(19) United States
(12) Patent Application Publication
(10) Pub. No.: US 2004/0145400 A1
(43) Pub. Date: Jul. 29, 2004

(54) Method for generating an internal clock pulse in an electric circuit and a corresponding electric circuit comprising a central clock-pulse generator

(76) Inventor: Athanase Mariggis, Munchen (DE)

Correspondence Address: MORRISON & FOERSTER LLP, 1650 TYSONS BOULEVARD, SUITE 300, MCLEAN, VA, 22102, US

(21) Appl. No.: 10/477,221

(22) PCT Filed: Apr. 4, 2002
(86) PCT No.: PCT/DE02/01343

(30) Foreign Application Priority Data
May 11, 2001 (DE) 101 23 932.7

(51) Int. Cl. G06F 1/04

(52) U.S. Cl. 327/291

(57) ABSTRACT

The invention relates to a method for generating an internal clock pulse in an electric circuit, using a first clock-pulse generator (1) and a second clock-pulse generator (2), each of said generators (1, 2) having at least one connection for an external reference clock-pulse source (7, 8) and at least a first (3, 4) and a second (5, 6) phase-locked loop (PLL). The respective first PLLs (3, 4) of both clock-pulse generators (1, 2) are synchronised to clock-pulse signals of different reference clock-pulse sources (7, 8). The second PLL (6) of the second clock-pulse generator (2) and the second PLL (5) of the first clock-pulse generator (1) generate signals based on clock-pulse signals provided by the first PLL (3) of the first clock-pulse generator (1), or the second PLL (6) of the second clock-pulse generator (2) and the second PLL (5) of the first clock-pulse generator (1) generate signals based on clock-pulse signals provided by the first PLL (4) of the second clock-pulse generator (2), as soon as said second generator (2) ascertains that no clock-pulse signals are being provided by the first PLL (3) of the first clock-pulse generator (1). The invention also relates to an electric circuit that can be used accordingly.

### DESCRIPTION

Method for production of an internal clock in an electrical circuit, and corresponding electrical circuit having a central clock generator.

The invention relates to a method for production of an internal clock in an electrical circuit, and to a corresponding electrical circuit having a central clock generator for production of an internal clock. In particular, the invention in this case relates to a telecommunications system having a central clock generator for production of an internal clock. Telecommunications systems are used for all telecommunications transmission methods in which communication is provided over a relatively long distance. The transmission technique comprises a channel transmission technique, speech and data radio, satellite technology, modems, digital switching systems and switching technology as well as local area networks. In this case, a fundamental distinction is drawn between asynchronous and synchronous transmission. Asynchronous transmission means that messages are interchanged from a transmitter to a receiver, decoupled in time. In contrast, synchronous transmission means synchronicity between the transmitter and receiver. In this case, a transmitting operation and the associated receiving operation must always be carried out at the same time. Telecommunications networks are identified by the capability for bidirectional and multidirectional data interchange between the subscribers. This is dependent on each subscriber who is involved being able to communicate with any other via the same medium. Owing to the different standards for transmission networks, communications systems are required which can set up connections to two or more of these transmission networks. One such telecommunications system has a dedicated interface for each different transmission standard.

Digital systems which are interconnected must be synchronized to one another since, if this is not done, a considerable loss of data must be accepted. If the clock supplies for two coupled systems diverge excessively from one another in this case, then the system must, if appropriate, be synchronized to the next frame of the transmission system, so that a portion of a frame is lost. Mobile radio and landline network communications systems generally include a central clock generator which should be synchronized with very high accuracy to an external clock source. In order to improve the reliability, at least two redundant, high-precision reference clocks are generally used. In addition, the entire central clock generator is generally duplicated. With regard to synchronization, a fundamental distinction can be drawn between plesiochronous synchronization, mutual synchronization and hierarchical synchronization (master/slave).

In the case of hierarchical master/slave synchronization, which also forms the basis of the present invention, the network is synchronized in accordance with a hierarchy, that is to say the respective lower level of the network is synchronized to the upper level. A digital switching system is generally synchronized by means of an internal clock which is produced by a central clock generator. A central clock generator such as this advantageously operates using the master/slave mode. Telecommunications systems which are connected to standardized transmission networks, such as PDH, SDH or SONET, generally require synchronization. This is the only way to achieve the necessary clock quality at the interface to the transmission network. In this case, a distinction is drawn between two synchronization operating modes. In the case of external synchronization, the system is supplied with a clock directly from an external synchronization source. In contrast, in the case of synchronization via the transmission path, the clock is obtained from the received data stream at the interface, and is supplied to the system as a synchronization source. Since the clock quality of a clock source to which the system is synchronized is variable and a reference clock may also fail, at least two mutually redundant reference clocks are used for synchronization of telecommunications systems. In this case, the failing or any reduction in quality of a reference clock must be identified by the telecommunications system, so that an automatic change is then made to the redundant reference clock. In general, when using the master/slave mode, the master in the synchronization system is synchronized under the control of a main processor to an external clock which is obtained via an interface from one of the transmission systems. The external clock source is likewise connected to a second clock generator, which is located in the slave of the central clock generator. This ensures that the entire system is synchronized by means of one, and only one, external clock source. When the master and slave function of the two clock generators of the central clock generator are interchanged, a main processor generally coordinates the changeover. One disadvantage in this case is the large amount of time involved. If the master fails or is switched off, this can therefore lead to shifts in the clock frequency and thus to faults on the transmission paths if the slave cannot take over the task of the master sufficiently quickly. In order to avoid this problem, EP 0 982 889 proposes that the slave produce its clock signals in synchronism with the clock signals of the reference clock source, and that the clock signals that are produced be made available to the first clock generator via a suitable electrical connection, as soon as the slave determines via a further suitable electrical connection that the clock signals being produced by the master have failed. There is therefore no longer any need for complex message traffic with a high-level processor. In conjunction with this problem EP 0 982 890 also proposes that quality detectors be provided on peripheral platforms in the telecommunications system, to detect any decrease of the quality or failure of a clock signal, and to interrupt the process of passing on the clock signal to the corresponding main clock generator. The main clock generator uses an interruption detector to detect the interruption, and switches to a redundant reference clock. The use of quality detectors in peripheral assemblies, with the aim of testing the clock quality in advance, is highly complex and expensive because, on the one hand, quality detectors are required in each peripheral assembly which is intended to produce a reference clock and, on the other hand, because detectors such as these require expensive crystal oscillators for testing the quality of the signal.

One object of the present invention was to provide a method in which it is possible to guarantee a required quality of an internal clock within an electrical circuit in a quite simple and low-cost manner. A further object of the invention was to provide a corresponding electrical circuit.

These objects are achieved by a method according to the invention as claimed in claim 1, and by an electrical circuit according to the invention as claimed in claim 3. Further advantageous embodiments are described in the appropriate dependent claims.

According to claim 1, a method is provided for production of an internal clock in an electrical circuit having a first clock generator and a second clock generator, with both clock generators each having at least one connection for an external reference clock source and each having at least one first PLL and one second PLL, and with the respective first PLLs of the two clock generators being synchronized to clock signals from respectively different reference clock sources, and with the second PLL for the second clock generator and the second PLL for the first clock generator producing clock signals on the basis of clock signals which are produced by the first PLL for the first clock generator, when the first PLL for the first clock generator produces clock signals and the second PLL for the second clock generator and the second PLL for the first clock generator produce clock signals on the basis of clock signals which are produced by the first PLL for the second clock generator as soon as the second clock generator determines that no clock signals are being produced by the first PLL for the first clock generator.

In principle, each clock generator contains at least two PLLs (phase locked loops). A first PLL comprises a high-precision, but low-frequency oscillator. This is required in order to achieve the quality for the clock that is required. In general, high-precision oscillators such as these are very expensive. The second PLL normally produces the high-frequency clock that is produced and ensures that there is a phase relationship, as stipulated by appropriate standards, between the two clock generators or between the master and slave. The second PLL thus has a type of multiplier function with respect to the clock signal produced by the first PLL.

In known systems, such as EWSD or EWSP, both parts of the redundant clock generator are synchronized to the same reference clock, or the slave is indirectly synchronized to the master, for example as for the MainstreetXpress 36190.

Now, in contrast, according to the present invention, the first PLL for the first clock generator, preferably a master clock generator, and the first PLL for the second clock generator, preferably a slave clock generator, are synchronized to different reference clocks. In one preferred embodiment of the method, this is done at the same time. The quality of the two external reference clocks is thus checked at the same time. Furthermore, it is also possible to feed in two or more reference clocks and, for example, to test or monitor their quality, for example by means of cyclic control, by the first PLL for the slave clock generator.

The second PLL for the second clock generator or the slave clock generator produces, however, clock signals based on the clock signals which are produced by the first PLL for the first clock generator or the master clock generator. Two identical redundant clock signals are thus produced during normal operation.

Failure of the clock signal from the first PLL for the first clock generator is identified by the second generator, and is regarded as a stimulus to carry out a switching process, to be precise such that the second PLL for the second clock generator now produces clock signals which are based on the clock signals that are produced by the first PLL for the second clock generator. In the same way, switching takes place in the first clock generator, such that the second PLL for the first clock generator likewise produces clock signals which are based on clock signals that are produced by the first PLL for the second clock generator. One major advantage of the present invention is that the switching process does not involve any loss of time whatsoever, since the first PLLs for the two clock generators at the same time test the quality of two different external reference clocks. In general, the first high-precision PLLs remain synchronized for several hours, while the subsequent synchronization of the second PLLs takes place relatively quickly. If switching is now required since, for example, a first reference clock to which the first PLL for the first clock generator is intended to be synchronized does not have the appropriate quality, then, according to the invention, the first PLL for the second clock generator produces clock signals which are already synchronized to a second reference clock, without any time delay. In previous systems, when switching was necessary due to possible lack of quality of a first reference clock, it was first of all necessary to check the quality of a second reference clock which, as already mentioned, takes a long time. It is thus possible for shifts in the clock frequency, and hence errors to occur, and this can be prevented by the method according to the invention since, in this case, the quality of two different reference clocks is tested at the same time, and not successively.

A further object of the present invention was to provide an electrical circuit using which an internal clock of a required quality can be made available.

According to the invention, this object is achieved by an electrical circuit having a central clock generator for production of an internal clock, with the central clock generator having at least the following elements: a first clock generator and a second clock generator each having at least one connection for an external reference source and each having at least one first PLL and one second PLL,

at least one first switchable connection between the first clock generator and the second clock generator, in order to pass on a clock signal from the first clock generator to the second clock generator,

at least one second switchable connection between the first clock generator and the second clock generator, for passing on a clock signal from the second clock generator to the first clock generator, and in which case the respective first PLLs of the two clock generators are synchronized in clock signals from respectively different reference clock sources, and in which the second PLL .for the second clock generator can produce clock signals via the at least one first switchable connection between the first clock generator and the second clock generator, on the basis of clock signals which are produced by the first PLL for the first clock generator, and the second PLL for the first clock generator can produce clock signals via the at least one second switchable connection between the first clock generator and the second clock generator on the basis of clock signals which are produced by the first PLL for the second clock generator, with the respective second PLLs always producing clock signals on the basis of the same clock signals.

This means that the second PLL for the first clock generator produces only clock signals based on the clock signals which are produced by the first PLL for the second clock generator, when the second PLL for the second clock generator likewise produces clock signals based on clock signals which are produced by the first PLL for the second clock generator. The same is true when the second PLL for the first clock generator produces clock signals which are based on clock signals which are made available by the first PLL for the first clock generator. Specifically, this is because the second PLL for the second clock generator also produces clock signals based on clock signals which are produced by the first PLL for the first clock generator.

In one preferred embodiment of the electrical circuit according to the invention, the second clock generator has at least the following further elements:

a detector device for detection of the absence of the clock signal which is produced by the first PLL for the first clock generator,

a switching apparatus for selection of a clock signal, on the basis of which the second PLL for the second clock generator produces its clock signal, with the switching apparatus selecting as the basis the clock signal which is produced by the first PLL for the first clock generator, as long as the detector device detects no absence, and with the switching apparatus selecting as the basis the clock signal which is produced by the first PLL for the second clock generator when the detector device detects absence, and in that

the first clock generator has at least the following further elements:

a detector device for detection of a clock signal which is produced by the first PLL for the second clock generator,

a switching apparatus for selection of a clock signal, on the basis of which the second PLL for the first clock generator produces its clock signal, with the switching apparatus selecting as the basis the clock signal which is produced by the first PLL for the first clock generator for as long as the detector device for the second clock generator detects no absence, and with the switching apparatus selecting as the basis the clock signal which is produced by the first PLL for the second clock generator when the detector device detects absence.

The electrical circuit preferably represents a telecommunications system which can be connected to at least one of two or more different transmission networks, and can transmit data via this at least one transmission network. The telecommunications system can preferably be connected to two or more transmission networks. These two or more transmission networks particularly preferably comprise a transmission network in accordance with the SDH transmission standard.

Furthermore, the two or more transmission networks preferably comprise a transmission network according to the PDH transmission standard and/or a transmission network according to the SONET transmission standard.

Further advantages of the present invention will be explained with reference to the following figure, in which:

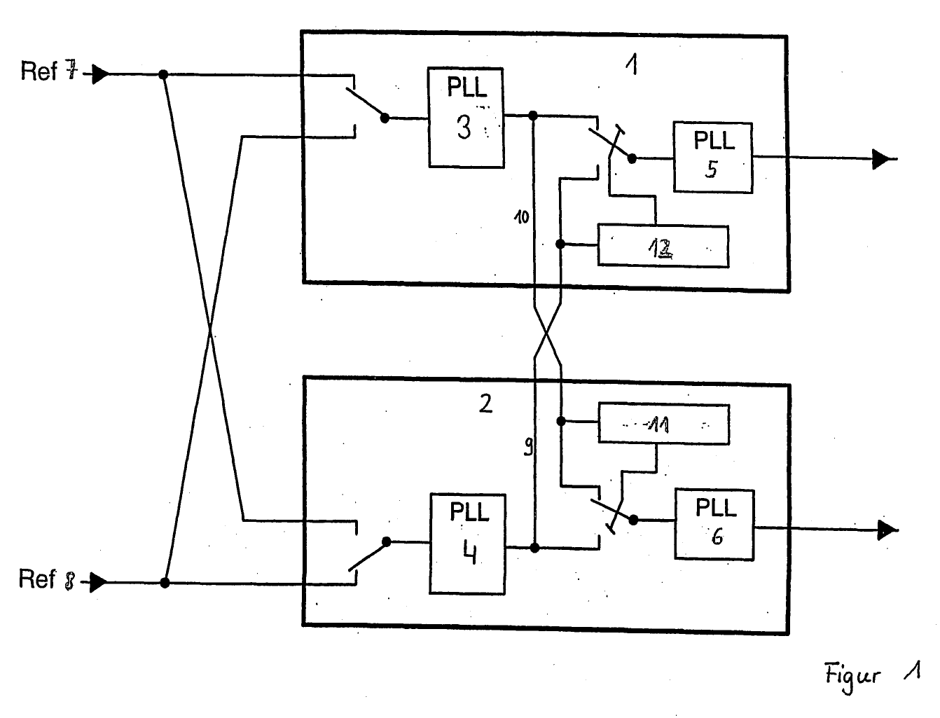

FIG. 1 shows a schematic illustration of one embodiment of a central clock generator for a circuit according to the invention.

FIG. 1 shows a constellation, on which the invention is based, of a central clock generator for an electrical circuit according to the invention. A first clock generator 1 and a second clock generator 2 each have a first PLL 3, 4 and a second PLL 5, 6. The first PLL 3 for the first clock generator 1 is supplied from an external clock 7, while the first PLL 4 for the second clock generator 2 is supplied from an external clock 8. This can also be interchanged by appropriate switching apparatuses, so that the PLL 3 is supplied from the external clock 8, and the PLL 4 is supplied from the external clock 7. In addition, switchable electrical connections 9, 10 are provided between the two clock generators 1 and 2 in order to pass on the clock signals. Normally, both clock generators are operated in the master/slave mode. The first PLL 3 for the first clock generator 1 produces clock signals based on the external clock 7. At the same time, the first PLL 4 for the second clock generator 2 produces clock signals which are produced on the basis of the external clock 8. The second PLL 5 for the first clock generator 1 then produces clock signals based on the clock signals which are produced by the first PLL 3 for the first clock generator 1. The second PLL 6 for the second clock generator 2 likewise produces clock signals for the clock signals of the first PLL 3 for the first clock generator 1, and these are made available to it via the connection 10. If a fault occurs on the connection 10, this can be detected with the aid of a detector device 11. Switching is then carried out such that the second PLL 6 for the second clock generator 2 produces clock signals which are based on the clock signals that are made available by the first PLL 4 for the second clock generator 2. At the same time, the second PLL 5 for the first clock generator 1 also produces clock signals based on the clock signals which are made available to it via the connection 9 from the first PLL 4 for the second clock generator 2. A detector device 12 in the connection 9 identifies when a clock signal is being produced on the connection 9. In consequence, the second PLL 5 for the first clock generator 1 identifies that the first PLL 3 for the first clock generator 1 is not able to produce a clock signal of the required quality and, as already explained, is switched over appropriately.

1. A method for production of an internal clock in an electrical circuit having
a first clock generator (1) and a second clock generator (2), with both clock generators (1, 2) each having at least one connection for an external reference clock source (7, 8) and each having at least one first PLL (3, 4) and one second PLL (5, 6)
characterized in that
the respective first PLLs (3, 4) of the two clock generators (1, 2) are synchronized to clock signals from respectively different reference clock sources (7, 8),
and in that the second PLL (6) for the second clock generator (2) and the second PLL (5) for the first clock generator (1) produce clock signals on the basis of clock signals which are produced by the first PLL (3) for the first clock generator (1), when the first PLL (3) for the first clock generator (1) produces clock signals, and
in that the second PLL (6) for the second clock generator (2) and the second PLL (5) for the first clock generator (1) produce clock signals on the basis of clock signals which are produced by the first PLL (4) for the second clock generator (2) as soon as the second clock generator (2) determines that no clock signals are being produced by the first PLL (3) for the first clock generator (1).

2. The method as claimed in claim 1, characterized in that each of the first PLLs of the two clock generators are at the same time synchronized in clock signals from respectively different reference clock sources.

3. An electrical circuit having a central clock generator for production of an internal clock, with the central clock generator having at least the following elements:
a first clock generator (1) and a second clock generator (2) each having at least one connection for an external reference source (7, 8) and each having at least one first PLL (3, 4) and one second PLL (5, 6), at least one first switchable connection (10) between the first clock generator (1) and the second clock generator (2), in order to pass on a clock signal from the first clock generator (1) to the second clock generator (2),
at least one second switchable connection (9) between the first clock generator (1) and the second clock generator (2), for passing on a clock signal from the second clock generator to the first clock generator (1),
characterized in that
the respective first PLLs (3, 4) of the two clock generators (1, 2) are synchronized in clock signals from respectively different reference clock sources (7, 8), and
in that the second PLL (6) for the second clock generator (2) can produce clock signals via the at least one first switchable connection (10) between the first clock generator (1) and the second clock generator (2), on the basis of clock signals which are produced by the first PLL (3) for the first clock generator (1), and the second PLL (5) for the first clock generator (1) can produce clock signals via the at least one second switchable connection (9) between the first clock generator (1) and the second clock generator (2) on the basis of clock signals which are produced by the first PLL (4) for the second clock generator (2), with the respective second PLLs (5, 6) always producing clock signals on the basis of the same clock signals.

4. The electrical circuit as claimed in claim 3
characterized in that
the second clock generator has at least the following further elements:
a detector device (11) for detection of the absence of the clock signal which is produced by the first PLL (3) for the first clock generator (1),
a switching apparatus for selection of a clock signal, on the basis of which the second PLL (6) for the second clock generator (2) produces its clock signal, with the switching apparatus selecting as the basis the clock signal which is produced by the first PLL (3) for the first clock generator, as long as the detector device (11). detects no absence, and with the switching apparatus selecting as the basis the clock signal which is produced by the first PLL (4) for the second clock generator (2) when the detector device (11) detects absence, and in that
the first clock generator (1) has at least the following further elements:
a detector device (12) for detection of a clock signal which is produced by the first PLL (4) for the second clock generator (2),
a switching apparatus for selection of a clock signal, on the basis of which the second PLL (5) for the first clock generator (1) produces its clock signal, with the switching apparatus selecting as the basis the clock signal which is produced by the first PLL (3) for the first clock generator (1) for as long as the detector device (11) for the second clock generator (2) detects no absence, and with the switching apparatus selecting as the basis the clock signal which is produced by the first PLL (4) for the second clock generator (2) when the detector device (11) detects absence.

5. The electrical circuit as claimed in one of claims 3 or 4,
characterized in that
the electrical circuit represents a telecommunications system which can be connected to at least one of two or more different transmission networks, in particular to the overall majority, and can transmit data via it or them.

6. The electrical circuit as claimed in claim 5,
characterized in that
the two or more transmission networks comprise a transmission network in accordance with the SDH transmission standard.

7. The electrical circuit as claimed in claim 5 or 6,
characterized in that
the two or more transmission networks comprise a transmission network according to the PDH transmission standard.

8. The electrical circuit as claimed in claims 5 to 7,
characterized in that
the two or more transmission networks comprise a transmission network according to the SONET transmission standard.
